(19) United States
(12) Patent Application Publication
(10) Pub. No.: US 2014/0210806 A1
(43) Pub. Date: Jul. 31, 2014

(54) Organic Light Emitting Display Device and Method and Driving Circuit for Prolonging Half-life Period Thereof

(71) Applicant: Shenzhen China Star Optoelectronics Technology Co. Ltd., Shenzhen, Guangdong (CN)

(72) Inventor: Tai-jiun Hwang, Shenzhen City (CN)

(73) Assignee: Shenzhen China Star Optoelectronics Technology Co., Ltd., Shenzhen Guangdong (CN)

(21) Appl. No.: 13/820,506

(22) PCT Filed: Jan. 31, 2013
(86) PCT No.: PCT/CN13/71195

§ 371 Date: Mar. 2, 2013

(30) Foreign Application Priority Data
Jan. 29, 2013 (CN) 201310033689.3

(51) Int. Cl. G09G 3/32

(52) U.S. Cl. CPC G09G 3/3283
USPC 345/211; 345/82

(57) ABSTRACT

An OLED device includes a power detection unit for detecting a power detection signal when turning on, a test image generation unit for generating a test image signal when a selection unit selects the test image signal to transmit according to the power detection signal and a timing control unit drives an OLED panel according to the test image signal, a current-adjusting unit for adjusting and holding real-time current complying with a predetermined current if the current-adjusting unit detects that the real-time current of the OLED panel is lower than the predetermined current, and a normal image signal input terminal for inputting normal image signal to control the selection unit to transmit the normal image signal, and then the OLED panel displays a normal image according to normal image signal from the timing control unit and the hold real-time current complying with the predetermined current provided by the current-adjusting unit.

### BACKGROUND OF THE INVENTION

1. Field of the Invention

The present invention relates to an organic light emitting display (OLED) field, more particularly, to an OLED device and a method and a driving circuit for prolonging its half-life period.

2. Description of the Prior Art

Organic light emitting display (OLED) device is a popular display technology in recent years. Compared with a traditional liquid crystal display (LCD), the OLED device has advantages, such as self-lightening, broad visual angles, quick response, high lightening efficiency, low operation voltage, a thin and flexible panel, wide range of working temparature, and low producing cost but short life. Therefore, the OLED device is considered a main display technology for next generation.

Brightness of an OLED device weakens with time, and life T50, half-life period, means the time it takes that the brightness of the OLED device weakens to half of original brightness. The longer half-life period is, the better it is. The reason of weakness of brightness is that current provided to the OLED panel declines. Therefore, it prolongs half-life period if it provides sufficient current complying with the predetermined current to the OLED panel upon the condition that the current is lower than that for normal brightness of the OLED panel.

### SUMMARY OF THE INVENTION

According to the present invention, an organic light emitting display (OLED) device comprises: an OLED panel for displaying an image; a power detection unit for generating a power detection signal from the OLED device when the OLED device turns on; a testing image generation unit for generating a testing image signal; a selection unit for selecting to transmit the test image signal upon receiving the power detection signal; a timing control unit for driving the OLED panel to display a test image according to the test image signal; a current-adjusting unit for adjusting a real-time current complying with a predetermined current and holding the real-time current complying with the predetermined current if the current-adjusting unit detects that the real-time current of the OLED panel provided by a power circuit is lower than the predetermined current when the test image is displayed; and a normal image signal input terminal for inputting a normal image signal. The selection unit selects to transmit the normal image signal upon receiving the normal image signal. The OLED panel displays a normal image using the hold real-time current complying with the predetermined current provided by the current-adjusting unit and receiving the driving normal image signal from the timing control unit.

In one aspect of the present invention, the current-adjusting unit comprises a current detection unit and a half-life period control unit, the half-life period control unit generates a control signal to change a voltage from the power circuit to adjust the real-time current complying with the predetermined current and holds the real-time current complying with the predetermined current when the current detection unit detects that the real-time current of the OLED panel provided by the power circuit is lower than the predetermined current.

In another aspect of the present invention, the OLED device further comprises a timing unit for generating a time signal when a predetermined time is up. The selection unit selects the test image signal to transmit according to the time signal when the OLED panel displays the normal image.

In still another aspect of the present invention, the OLED device further comprises an external control signal input terminal for inputting an external control signal. The selection unit selects the test image signal to transmit according to the time signal when the OLED panel displays the normal image.

According to the present invention, a method for prolonging a half-life period of an OLED device comprises: a) detecting a power detection signal from the OLED device while the OLED device turns on; b) generating a test image signal; c) transmitting the test image signal when a selection unit receives the power detection signal; d) driving the OLED panel to display a test image according to the test image signal; e) detecting a real-time current from a power circuit to the OLED panel and comparing the detected real-time current with a predetermined current; f) adjusting the real-time current complying with the predetermined current and holding the real-time current complying with the predetermined current if the real-time current is lower than the predetermined current; g) transmitting the normal image signal when the selection unit receives the normal image signal, driving the OLED panel according to the normal image signal and providing the hold real-time current complying with the predetermined current to the OLED panel so that the OLED panel displays the normal image.

In one aspect of the present invention, the OLED device comprises a timing unit for generating a time signal when a predetermined time is up. The step g) comprises: transmitting the test image signal when the selection unit receives the time signal and then return the step d).

In another aspect of the present invention, the OLED device comprises an external control signal input terminal for inputting an external control signal. The step g) comprises: transmitting the test image signal when the selection unit receives the external control signal, and then return the step d).

According to the present invention, a driving circuit for driving an organic light emitting display (OLED) device, comprises: a power detection unit for generating a power detection signal when an OLED device having an OLED panel turns on; a testing image generation unit for generating a testing image signal; a selection unit for selecting to transmit the test image signal upon receiving the power detection signal; a timing control unit for driving the OLED panel to display a test image according to the test image signal; a current-adjusting unit for adjusting a real-time current complying with a predetermined current and holding the real-time current complying with the predetermined current if the current-adjusting unit detects that the real-time current of the OLED panel provided by a power circuit is lower than the predetermined current when the test image is displayed; and a normal image signal input terminal for inputting a normal image signal, wherein the selection unit selects to transmit the normal image signal upon receiving the normal image signal, and the OLED panel displaying a normal image by receiving the hold real-time current complying with the predetermined current provided by the current-adjusting unit and receiving the driving normal image signal from the timing control unit.

In one aspect of the present invention, the current-adjusting unit comprises a current detection unit and a half-life period control unit, the half-life period control unit generates a control signal to change a voltage from the power circuit to adjust the real-time current complying with the predetermined current and holds the real-time current complying with the predetermined current when the current detection unit detects that the real-time current of the OLED panel provided by the power circuit is lower than the predetermined current.

In another aspect of the present invention, the driving circuit further comprises a timing unit for generating a time signal when a predetermined time is up. The selection unit selects the test image signal to transmit according to the time signal when the OLED panel displays the normal image.

In still another aspect of the present invention, the driving circuit further comprises an external control signal input terminal for inputting an external control signal. The selection unit selects the test image signal to transmit according to the time signal when the OLED panel displays the normal image.

The present invention proposes an OLED device, a method, and a driving circuit for prolonging a half-life period of the OLED device. By adjusting supply voltage from a power circuit to adjust an OLED panel real-time current complying with a predetermined current so that it prolongs half-life period of the OLED device. In other words, it prolongs life of the OLED device.

### BRIEF DESCRIPTION OF THE DRAWINGS

FIG. 1 shows a schematic diagram of the OLED device according to a preferred embodiment of the present invention.

FIG. 2 shows a flowchart of a method of prolong half-life period of the OLED device according to a preferred embodiment of the present invention.

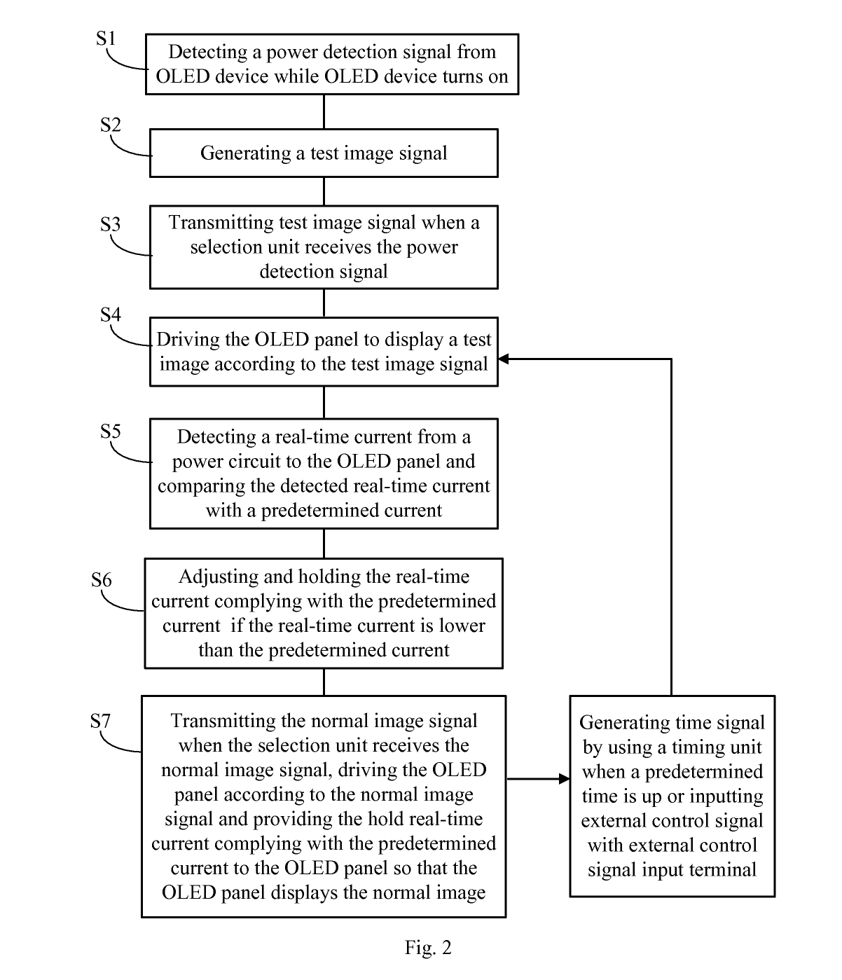

### DETAILED DESCRIPTION OF THE PREFERRED EMBODIMENTS

The features and advantages of the preferred embodiments of the present invention will be more apparent from the following detailed description taken in conjunction with the accompanying drawings.

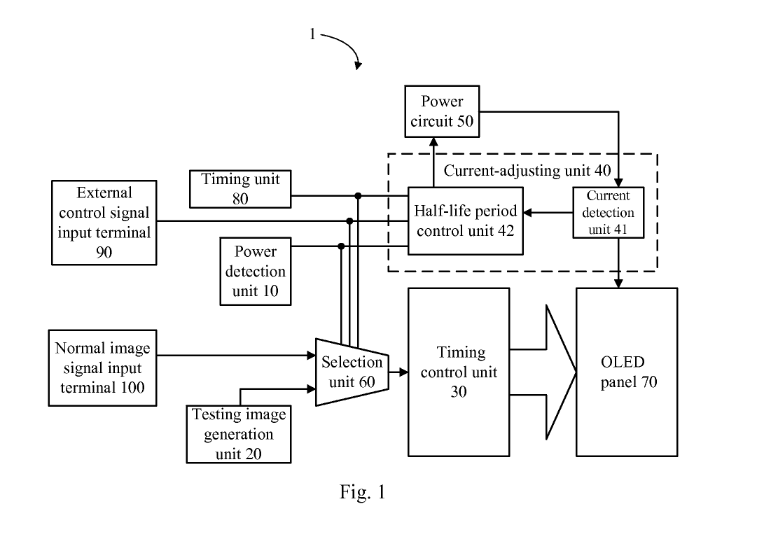

FIG. 1 shows a schematic diagram of the OLED device according to a preferred embodiment of the present invention.

Please refer to FIG. 1, an OLED device 1 comprises a power detection unit 10, a testing image generation unit 20, a timing control unit 30, a current-adjusting unit 40, a power circuit 50, a selection unit 60, a normal image signal input terminal 100 and an OLED panel 70. The current-adjusting unit 40 comprises a current detection unit 41 and a half-life period control unit 42. The selection unit 60 selects different image signals in response to different control signals, and the timing control unit 30 drives the OLED panel 70 to display different images according to the selected image signals. The detail is in the following.

Specifically, the power detection unit 10 generates a power detection signal from the OLED device 1 while the OLED device 1 turns on. The test image generation unit 20 generates a test image signal. The selection unit 60 tranmsits the test image signal according to the power detection signal. The timing control unit 30 drives the OLED panel 70 to display test image based on the test image signal after the test image signal is transmitted to timing control unit 30. During test image display, the current detection unit 41 detects that the power circuit 50 provides a real-time current to the OLED panel 70. Comparing the real-time current with a predetermined current, the half-life period control unit 42 generates a control signal to adjust supply voltage from the power circuit 50 to adjust the real-time current complying with the predetermined current when the real-time current is lower than the predetermined current. The real-time current is held in the half-life period control unit 42. The selection unit 60 selects normal image signal from a normal image signal input terminal 100 to transmit when the test image disappears. After the normal image signal is transmitted to the timing control unit 30, the timing control unit 30 drives the OLED panel 70 according to the normal image signal. In the meantime, the half-life period control unit 42 provides the hold real-time current complying with the predetermined current to the OLED panel 70 so that the OLED panel 70 displays normal images. It is noted that a user is not aware of the test image because time that the test image switches to the normal image is too short to be perceived.

Preferably, the predetermined current indicates a current corresponding to the OLED panel 70 displaying in normal brightness. Therefore, the OLED panel 70 displays darker brightness if a detected real-time current is lower than the predetermined current.

Besides, the OLED device 1 further comprises a timing unit 80 for calibrating a real-time current upon the condition that the real-time current is lower than the predermined current which means the OLED device 1 displays images in darker brightness in a long time period. The following is a detail of functions of the timing unit 80.

When the OLED device 1 displays normal images in long time, the timing unit 80 generates a time signal at a predetermined time. The selection unit 60 stops transmitting the normal image signal and selects a test image signal to transmit to the timing control unit 30 when receiving the timing signal. The timing control unit 30 drives the OLED panel 70 to display a test image according to the test image signal. In the period of the test image display, the current detection unit 41 detects whether the real-time current provided from the power circuit 50 to the OLED panel 70 is lower than the predetermined current. The half-life period control unit 42 generates a control signal to adjust supply voltage from the power circuit 50 to adjust the real-time current complying with the predetermined current. The real-time current is held in the half-life period control unit 42. The selection unit 60 transmits the normal image signal from the normal image signal input terminal 100 when the test image disappears. After the normal image signal is transmitted to the timing control unit 30, the timing control unit 30 drives the OLED panel 70 according to the normal image signal, and in the meantime, the half-life period control unit 42 provides the hold real-time current complying with the predetermined current to the OLED panel 70 so that the OLED panel 70 displays the normal image.

In addition, the OLED device 1 further comprises an external control signal input terminal 90 for calibrating a real-time current. When the OLED device 1 displays a normal image, the external control signal input terminal 90 inputs an external control signal to interrupt control of the normal image signal over the selection unit 60 if brightness of the OLED panel 70 decreases, i.e. the real-time current provided to the OLED panel 70 is lower than the predetermined current. And then, the selection unit 60 transmits the test image signal to the timing control unit 30 when receiving the external control signal. The timing control unit 30 drives the OLED panel 70 to display the test image according to the test image signal. During the test image display, the current detection unit 41 detects whether the real-time current provided from the power circuit 50 to the OLED panel 70 is lower than the predetermined current. The half-life period control unit 42 generates a control signal to adjust supply voltage from the power circuit 50 to adjust the real-time current complying with the predetermined current. The real-time current is held in the half-life period control unit 42. The selection unit 60 transmits the normal image signal from the normal image signal input terminal 100 when the test image disappears. After the normal image signal is transmitted to the timing control unit 30, the timing control unit 30 drives the OLED panel 70 according to the normal image signal, and in the meantime, the half-life period control unit 42 provides the hold real-time current complying with the predetermined current to the OLED panel 70 so that the OLED panel 70 displays the normal image.

The present invention also provides a method for prolonging half-life period of an OLED deivce. The method comprises steps:

S1: detecting a power detection signal from the OLED device while the OLED device turns on;

S2: generating a test image signal;

S3: transmitting the test image signal when a selection unit receives the power detection signal;

S4: driving the OLED panel to display a test image according to the test image signal;

S5: detecting a real-time current from a power circuit to the OLED panel and comparing the detected real-time current with a predetermined current;

S6: adjusting the real-time current complying with the predetermined current and holding the real-time current complying with the predetermined current if the real-time current is lower than the predetermined current;

S7: transmitting the normal image signal when the selection unit receives the normal image signal, driving the OLED panel according to the normal image signal and providing the hold real-time current complying with the predetermined current to the OLED panel so that the OLED panel displays the normal image.

Moreover, it is able to return to the step S4 from the step S7 if the time signal generated by the timing unit at the predetermined time controls the selection unit to transmit the test image signal when the OLED panel displays a normal image.

In the same way, it is able to return to the step S4 from the step S7 if the external control signal input terminal by the external signal input of the OLED device at the predetermined time controls the selection unit to transmit the test image signal when the OLED panel displays a normal image.

Furthermore, the power detection unit 10, the testing image generation unit 20, the timing control unit 30, the current-adjusting unit 40, the power circuit 50, the selection unit 60, the normal image signal input terminal 100, the timing unit 80 and the external control signal input terminal 90 are integrated as a single driving circuit of the OLED device 1. The driving circuit is used for driving the OLED panel 70 to display images, and functions of the units has been illustrated above in detail.

In summary, the present invention changes supply voltage from the power circuit of the OLED device to adjust the OLED panel real-time current complying with the predetermined current so that it prolongs half-life period of the OLED device. In other words, it prolongs life of the OLED device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An organic light emitting display (OLED) device comprising:
an OLED panel for displaying an image;
a power detection unit for generating a power detection signal from the OLED device when the OLED device turns on;
a testing image generation unit for generating a testing image signal;
a selection unit for selecting to transmit the test image signal upon receiving the power detection signal;
a timing control unit for driving the OLED panel to display a test image according to the test image signal;
a current-adjusting unit for adjusting a real-time current complying with a predetermined current and holding the real-time current complying with the predetermined current if the current-adjusting unit detects that the real-time current of the OLED panel provided by a power circuit is lower than the predetermined current when the test image is displayed; and
a normal image signal input terminal for inputting a normal image signal,
wherein the selection unit selects to transmit the normal image signal upon receiving the normal image signal, and the OLED panel displays a normal image according to the normal image signal from the timing control unit and the hold real-time current complying with the predetermined current provided by the current-adjusting unit.

2. The OLED device of claim 1, wherein the current-adjusting unit comprises a current detection unit and a half-life period control unit, the half-life period control unit generates a control signal to change a voltage from the power circuit to adjust the real-time current complying with the predetermined current and holds the real-time current complying with the predetermined current when the current detection unit detects that the real-time current of the OLED panel provided by the power circuit is lower than the predetermined current.

3. The OLED device of claim 1 further comprising a timing unit for generating a time signal when a predetermined time is up, and the selection unit selects the test image signal to transmit according to the time signal when the OLED panel displays the normal image.

4. The OLED device of claim 2 further comprising a timing unit for generating a time signal when a predetermined time is up, and the selection unit selects the test image signal to transmit according to the time signal when the OLED panel displays the normal image.

5. The OLED device of claim 1 further comprising an external control signal input terminal for inputting an external control signal, and the selection unit selects the test image signal to transmit according to the time signal when the OLED panel displays the normal image.

6. The OLED device of claim 2 further comprising an external control signal input terminal for inputting an external control signal, and the selection unit selects the test image signal to transmit according to the time signal when the OLED panel displays the normal image.

7. A method for prolonging a half-life period of an OLED device, comprising:
a) detecting a power detection signal from the OLED device while the OLED device turns on;
b) generating a test image signal;
c) transmitting the test image signal when a selection unit receives the power detection signal;
d) driving the OLED panel to display a test image according to the test image signal;
e) detecting a real-time current from a power circuit to the OLED panel and comparing the detected real-time current with a predetermined current;
f) adjusting the real-time current complying with the predetermined current and holding the real-time current complying with the predetermined current if the real-time current is lower than the predetermined current;
g) transmitting the normal image signal when the selection unit receives the normal image signal, driving the OLED panel according to the normal image signal and providing the hold real-time current complying with the predetermined current to the OLED panel so that the OLED panel displays the normal image.

8. The method of claim 7, wherein the OLED device comprises a timing unit for generating a time signal when a predetermined time is up, and the step g) comprises: transmitting the test image signal when the selection unit receives the time signal and then return the step d).

9. The method of claim 7, wherein the OLED device comprises an external control signal input terminal for inputting an external control signal, and the step g) comprises: transmitting the test image signal when the selection unit receives the external control signal, and then return the step d).

10. A driving circuit for driving an organic light emitting display (OLED) device, comprising:
a power detection unit for generating a power detection signal when an OLED device having an OLED panel turns on;
a testing image generation unit for generating a testing image signal;
a selection unit for selecting to transmit the test image signal upon receiving the power detection signal;
a timing control unit for driving the OLED panel to display a test image according to the test image signal;
a current-adjusting unit for adjusting a real-time current complying with a predetermined current and holding the real-time current complying with the predetermined current if the current-adjusting unit detects that the real-time current of the OLED panel provided by a power circuit is lower than the predetermined current when the test image is displayed; and
a normal image signal input terminal for inputting a normal image signal,
wherein the selection unit selects to transmit the normal image signal upon receiving the normal image signal, and the OLED panel displays a normal image according to the normal image signal from the timing control unit and the hold real-time current complying with the predetermined current provided by the current-adjusting unit.

11. The driving circuit of claim 10, wherein the current-adjusting unit comprises a current detection unit and a half-life period control unit, the half-life period control unit generates a control signal to change a voltage from the power circuit to adjust the real-time current complying with the predetermined current and holds the real-time current complying with the predetermined current when the current detection unit detects that the real-time current of the OLED panel provided by the power circuit is lower than the predetermined current.

12. The driving circuit of claim 10 further comprising a timing unit for generating a time signal when a predetermined time is up, and the selection unit selects the test image signal to transmit according to the time signal when the OLED panel displays the normal image.

13. The driving circuit of claim 11 further comprising a timing unit for generating a time signal when a predetermined time is up, and the selection unit selects the test image signal to transmit according to the time signal when the OLED panel displays the normal image.

14. The driving circuit of claim 10 further comprising an external control signal input terminal for inputting an external control signal, and the selection unit selects the test image signal to transmit according to the time signal when the OLED panel displays the normal image.

15. The driving circuit of claim 11 further comprising an external control signal input terminal for inputting an external control signal, and the selection unit selects the test image signal to transmit according to the time signal when the OLED panel displays the normal image.
